(19) United States
(12) Patent Application Publication
(10) Pub. No.: US 2025/0155386 A1
(43) Pub. Date: May 15, 2025

(54) X-RAY ANALYSIS APPARATUS, ANALYSIS METHOD, AND COMPUTER PROGRAM PRODUCT

(71) Applicant: Samsung Electronics Co, Ltd., Suwon-si (KR)

(72) Inventors: Koji Murata, Yokohama City (JP); Jaeyong Lee, Suwon-si (KR); Yukihide Tsuji, Suwon-si (KR); Yoshinori Sasai, Yokohama City (JP)

(21) Appl. No.: 18/939,687

(22) Filed: Nov. 7, 2024

(30) Foreign Application Priority Data
Nov. 9, 2023 (JP) 2023-191409
Dec. 12, 2023 (KR) 10-2023-0179716

(51) Int. Cl. G01N 23/2055

(52) U.S. Cl. CPC G01N 23/2055

(57) ABSTRACT

An analysis device, an analysis method, and a computer program product that are configured to reduce an amount of time required to analyze scattering intensity distribution of X-rays are provided. An analysis device according to example embodiments includes an extraction circuit configured to extract information about an electron density difference at a different material interface included in a target structure and information about a surface element included at the different material interface from data representing the target structure, and a calculation circuit configured to calculate a surface integral at the different material interface based on the information about the electron density difference and the information about the surface element, and to calculate a scattering intensity distribution of X-rays irradiated to the target structure based on the surface integral.

### PRIORITY STATEMENT

This application claims priority under 35 U.S.C. § 119 to Japanese Patent Application No. 2023-191409, filed on Nov. 9, 2023, and Korean Patent Application No. 10-2023-0179716, filed on Dec. 12, 2023 in the Korean Intellectual Property Office (KIPO), the contents of which are herein incorporated by reference in their entirety.

### FIELD

Example embodiments relate to an analysis device, an analysis method, and a program. More particularly, example embodiments relate to an analysis device, an analysis method, and a program for analyzing scattering intensity distribution of X-rays.

### BACKGROUND

Some technologies for measuring a layer thickness of each layer of a stacked structure may utilize phase contrast imaging methods using X-rays, as described for example in Japanese Patent Laid-Open No. 2022-83881.

However, there may be demand for technologies that may reduce the amount of time that may be required to analyze the scattering intensity distribution of X-rays.

### SUMMARY

Example embodiments provide an analysis device that is configured to reduce the amount of time required to analyze scattering intensity distribution of X-rays.

Example embodiments provide an analysis method that is configured to reduce the amount of time required to analyze scattering intensity distribution of X-rays.

Example embodiments provide a computer program product for performing the above-described analysis method.

According to example embodiments, an analysis device includes an extraction circuit configured to extract information about an electron density difference at a different material interface included in a target structure and information about a surface element included at the different material interface from data representing the target structure; and a calculation circuit configured to calculate a surface integral at the different material interface based on the information about the electron density difference and the information about the surface element, and to calculate a scattering intensity distribution of X-rays irradiated to the target structure based on the surface integral that was calculated.

According to example embodiments, a method of operating an X-ray analysis device includes performing, by at least one processor of the X-ray analysis device, operations comprising extracting, from data representing a target structure, information about an electron density difference in a different material interface included in the target structure and information about a surface element included in the different material interface; calculating a surface integral at the different material interface based on the information about the electron density difference and the information about the surface element; and calculating a scattering intensity distribution of X-rays irradiated to the target structure based on the surface integral that was calculated.

According to example embodiments, a computer program product includes computer readable program code embodied in a non-transitory computer readable storage medium, which, when executed, causes a processor of a computer to execute operations comprising: extracting, from data representing a target structure, information about an electron density difference in a different material interface included in the target structure and information about a surface element included in the different material interface; calculating a surface integral at the different material interface based on the information about the electron density difference and the information about the surface element; and calculating a scattering intensity distribution of X-rays irradiated to the target structure based on the surface integral that was calculated.

According to example embodiments, an analysis device, an analysis method, and a computer program product that are configured to reduce the amount of time required to analyze the scattering intensity distribution of X-rays may be provided.

### BRIEF DESCRIPTION OF THE DRAWINGS

Example embodiments will be more clearly understood from the following detailed description taken in conjunction with the accompanying drawings.

FIGS. 1 to 13 represent non-limiting, example embodiments as described herein. FIG. 1 is a view explaining a scattering vector of X-ray that is irradiated to a target structure.

FIG. 2 is a block diagram illustrating an analysis device in accordance with an example embodiment.

FIG. 3 is a view illustrating an interface between different materials included in a target structure.

FIG. 4 is a perspective view illustrating an example of a target structure.

FIG. 5 is a view illustrating an analysis method in accordance with an example embodiment.

FIG. 6 is a perspective view illustrating an example expressed as a target structure according to a related art.

FIG. 7 is views explaining verification results of an analysis method in accordance with an example embodiment.

FIG. 8 is a view explaining effects of an example embodiment.

FIG. 9 is a view explaining effects of an example embodiment.

FIG. 10 is a view explaining effects of an example embodiment.

FIG. 11 is a view explaining effects of an example embodiment.

FIG. 12 is a view explaining effects of an example embodiment.

FIG. 13 is a view explaining effects of an example embodiment.

### DETAILED DESCRIPTION OF EXAMPLE EMBODIMENTS

Hereinafter, example embodiments will be explained in detail with reference to the accompanying drawings. The terms “first,” “second,” etc., may be used herein merely to distinguish one component, layer, direction, etc. from another. The terms “comprises,” “comprising,” “includes” and/or “including,” when used herein, specify the presence of stated elements, but do not preclude the presence of additional elements. The term “and/or” includes any and all combinations of one or more of the associated listed items. The term “connected” may be used herein to refer to a physical and/or electrical connection.

For clarity of explanation, appropriate omissions and simplifications have been made in following description and drawings, and the dimensions of structures are enlarged from actual figures to ensure clarity of the present inventive concept. Additionally, in each drawing, like elements are indicated by the same reference numerals, and duplicate descriptions are omitted as necessary.

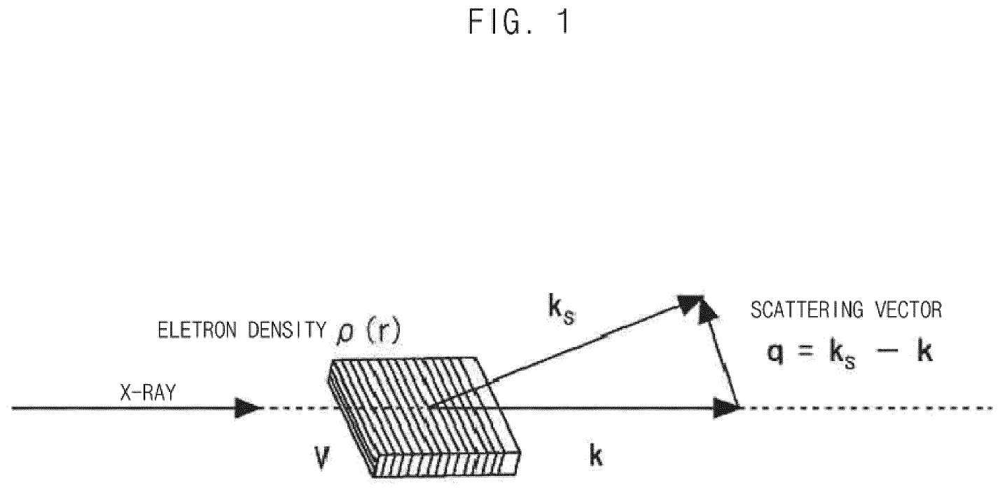

FIG. 1 is a view illustrating a scattering vector of X-ray when plane wave X-rays are irradiated onto a target structure having periodicity. In formulas shown below, alphanumeric characters or terms in bold (bold font) represent vectors. In the descriptions below, “(bold)” is used after the corresponding alphanumeric characters or terms.

A wave vector of X-ray may be expressed as k (bold), and a wave vector of a scattering vector may be expressed as ks (bold). A scattering vector q (bold) may be defined as ks (bold)−k (bold). In this case, scattering intensity distribution I (q (bold)) may be expressed as a square of the equation of three-dimensional Fourier transform that is obtained by solving the Schrödinger equation with the Born Approximation, as expressed in following Equation (1).

$$[ Equation 1 ]$$

$$I ( q ) = {\vert \frac{1}{V} \int \int {\int }_{V} ρ ( r ) exp ( - iq \cdot r ) {d}^{3} r \vert}^{2} \qquad ( 1 )$$

And, if the incident X-ray has a spread represented by the distribution W (bold), the scattering intensity distribution Ismear (q (bold)) may be calculated by two-dimensional convolution integral, as expressed in following Equation (2). While Ismear (q (bold)) is two-dimensional convolution integral, I (q (bold)) may be three-dimensional Fourier transform. Therefore, usually, the amount of time taken to calculate I (q (bold)) may be longer than the amount of time taken to calculate Ismear (q (bold)).

$$[ Equation 2 ]$$

$${I}_{smear} ( q ) = \int \int W ( k ) I ( q - k ) {d}^{2} k \qquad ( 2 )$$

In general, I (q (bold)) may be calculated for a target structure that is modeled as a combination of primitive shapes such as cuboid or cylinder for which the three-dimensional Fourier transform can be solved analytically. However, structural data obtained through process simulation or topography simulation that reflects physical processes generally cannot be expressed using only primitive shapes, and may need to be expressed as mesh data. In addition, since the integral (3D Fourier transform) for the structure expressed as mesh data cannot be solved analytically, it may be necessary to express the target structure as sufficiently fine rectangular mesh and then to solve the numerical integration, and accordingly, there is a problem that the amount of time required to analyze the scattering intensity distribution of X-rays is unreasonably long.

Therefore, embodiments of the present disclosure provide an analysis device, method of operating the analysis device, and computer program product that are configured to reduce the amount of time required to analyze the scattering intensity distribution when plane wave X-rays are irradiated onto a complex structure represented by a rectangular parallelepiped mesh.

### EXAMPLE EMBODIMENTS

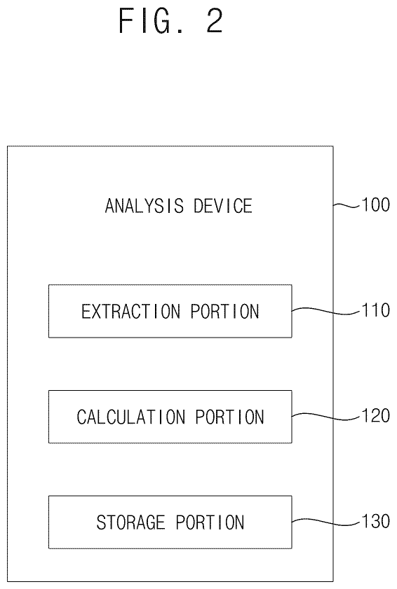

FIG. 2 is a block diagram illustrating an analysis device in accordance with example embodiments. The analysis device 100 may be a computer device that includes a processor that executes computer-readable program code (also referred to herein as a program) stored in a non-transitory memory. The analysis device 100 may include a plurality of computer devices. In this case, components or functions constituting the analysis device 100 may be distributed and arranged in a plurality of computer devices. The plurality of computer devices may be connected through a wired or wireless network or directly connected through a cable or the like. The processor may include CPU (Central Processing Unit), GPU (Graphics Processing Unit), FPGA (field-programmable gate array), etc.

The analysis device 100 may include an extraction portion or circuit 110, a calculation portion or circuit 120, and a storage portion or circuit 130. The storage circuit 130 may be implemented by a non-transitory storage device that is accessible by the processor.

The extraction circuit 110 may extract information about a difference in electron density at an interface between different materials included in a target structure and information about a surface element included at the interface between different materials, from data representing the target structure. The information regarding the electron density difference may represent a difference between a first electron density corresponding to a first side or front surface of the different material interface and a second electron density corresponding to a second side or backside surface of the different material interface. For example, if the surface element is a triangle, the surface element information may include coordinate information of three vertices of the triangle. However, it will be understood that a shape of the surface element may not be limited to a triangle.

The calculation circuit 120 may calculate a surface integral at the interface between different materials for calculating the scattering intensity distribution of X-rays irradiated to the target structure, based on the information about the electron density difference and the information about the surface element. The calculation circuit 120 may calculate the surface integral for each of a plurality of the surface elements and calculate the scattering intensity distribution as the sum of the surface integrals.

The target structure may include a plurality of different material interfaces. When the target structure includes a first different material interface and a second different material interface having a same shape, the extraction circuit 110 may store information about a surface element of the first different material interface in the storage circuit 130. Then, when calculating a surface integral at the second different material interface, the calculation circuit 120 may read the information regarding the first different material interface from the storage circuit 130 and may use information calculated from the read information as information about a surface element of the second different material interface.

Additionally, the calculation circuit 120 may classify the surface element into one of a plurality of groups according to a direction (X direction, Y direction, Z direction) of the surface element, and may calculate the scattering intensity distribution in consideration of the classification result. For example, the calculation circuit 120 can efficiently calculate the scattering intensity distribution by arranging information about surface elements classified into the same group in a continuous memory and performing the calculation.

Additionally, the calculation circuit 120 may process surface integrals at a plurality of surface elements in parallel. For example, the calculation circuit 120 may allocate the surface integral of each of the plurality of surface elements to one of a plurality of processor cores and execute parallel processing in the plurality of processor cores.

Hereinafter, reasons why the scattering intensity distribution of X-rays can be calculated based on the surface integral at the interface between different materials will be explained with reference to the formula. The scattering intensity distribution when a plane wave X-ray is irradiated to a target structure having periodicity may be calculated by a square of the equation of three-dimensional Fourier transform as expressed in the above-mentioned Equation (1). A vector field D (bold) (r (bold)) from which the integrand contained in Equation (1) diverges may be expressed by following Equation (3).

$$[ Equation 3 ]$$

$$D ( r ) = i \frac{{ρ}_{c}}{{q}^{2}} {e}^{- iq \cdot r} q ⇒ ∇ \cdot D ( r ) = {ρ}_{c} {e}^{- iq \cdot r} \qquad ( 3 )$$

ρ_{c} represents the electron density within the volume element.

The divergence of this vector field D (bold) (r (bold)) is substituted into the integrand of Equation (1). By the divergence theorem, the volume integral is calculated by the surface integral, as expressed by following Equation (4).

$$[ Equation 4 ]$$

$$\begin{matrix}{\int }_{V} {ρ}_{c} {e}^{- iq \cdot r} {d}^{3} r = {\int }_{V} ∇ \cdot D ( r ) {d}^{3} r = {\int }_{\partial S = V} D ( r ) \cdot dS \\ = {\int }_{\partial S = V} i \frac{{ρ}_{c}}{{q}^{2}} {e}^{- iq \cdot r} q \cdot dS \\ = i \frac{{ρ}_{c}}{{q}^{2}} {\int }_{\partial S = V} {e}^{- iq \cdot r} q \cdot dS\end{matrix} \qquad ( 4 )$$

For example, if the volume element is a tetrahedron composed of four triangular planes (area elements), the volume integral is calculated as the sum of the surface integrals at the four planes. Since volume elements are spread across the entire area of the analysis object, two area elements are paired inside the structure corresponding to one material. Unpaired area elements inside the structure are paired with vacuum, etc. Paying attention to the sum of the surface integrals on the area elements that are pairs of element numbers k and k′, the equations of the planes are the same and the directions of the area vectors are opposite, so Equation (5) holds.

$$[ Equation 5 ]$$

$$\frac{i {ρ}_{k}}{{q}^{2}} {\int }_{{S}_{k}} {e}^{- iq \cdot r} q \cdot {dS}_{k} + \frac{i {ρ}_{{k}^{′}}}{{q}^{2}} {\int }_{{S}_{{k}^{′}}} {e}^{- iq \cdot r} q \cdot {dS}_{{k}^{′}} = \frac{i}{{q}^{2}} ( {ρ}_{k} - {ρ}_{k ′} ) {\int }_{{S}_{k}} {e}^{- iq \cdot r} q \cdot {dS}_{k} \qquad ( 5 )$$

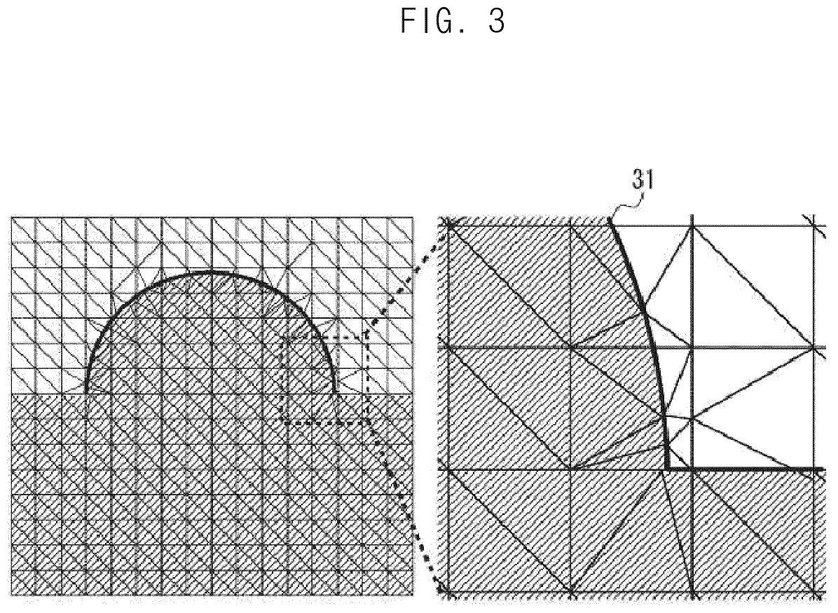

In other words, the surface integral at the interface between the same materials is canceled out, and only the interface between different materials contributes to the scattering intensity distribution. That is, the scattering intensity distribution may be calculated by extracting information about the different material interface represented by a curved surface 31 (or surface elements therealong) from the unstructured mesh data shown in FIG. 3 and calculating the sum of the surface integrals at these interfaces between different materials. Additionally, meshes with identical hatching correspond to the same material, i.e., the same electron density. The scattering intensity distribution of X-rays may be calculated as volume integral of volume elements included in unstructured mesh data, or the sum of surface integrals at interfaces of different materials.

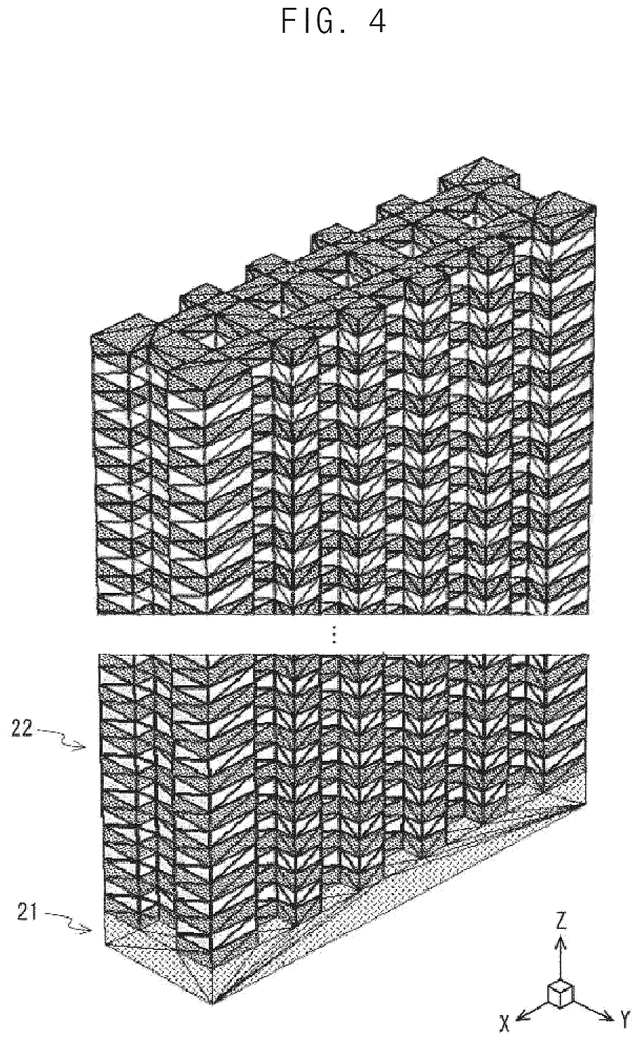

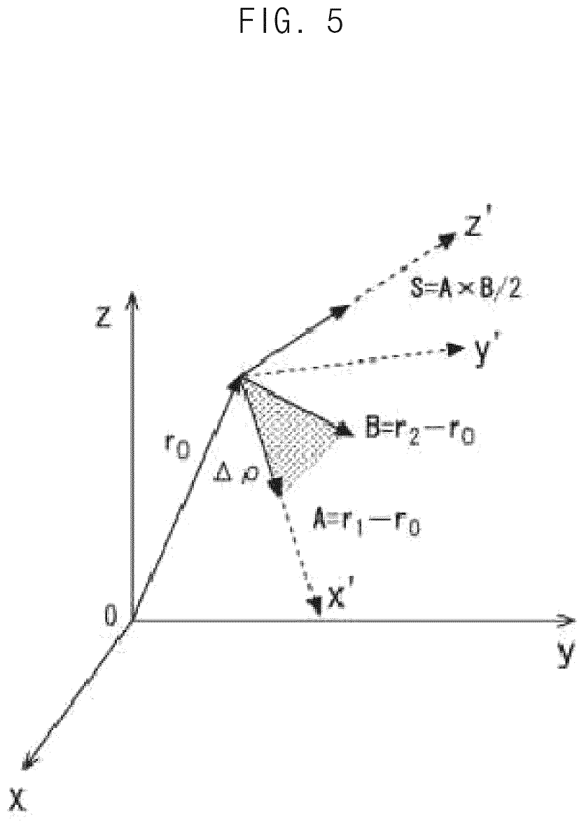

Hereinafter, an operation of the analysis device 100 will be described in detail with reference to FIGS. 4 and 5. Referring to FIG. 4, a hole of a rectangular parallelepiped shape is formed in a multilayer 22 on a substrate 21 of a rectangular parallelepiped shape. The substrate 21 and the multilayer 22 are stacked in Z direction. Meshes that are illustrated with the same hatching correspond to the same material, i.e., the same electron density.

First, the extraction circuit 110 of the analysis device 100 may extract information about a surface element included at or in an interface between different materials. FIG. 5 is a view illustrating an example of information about surface elements extracted by the extraction circuit 110. The extraction circuit 110 may extract, for example, coordinate information represented by r0 (bold), r1 (bold), and r2 (bold) and an electron density difference Δρ. Then, A (bold)=r1 (bold)−r0 (bold) may be calculated, B (bold)=r2 (bold)−r0 (bold) may be calculated, and S (bold)=(A (bold)×B (bold))/2 may be calculated.

Based on the extracted information, the calculation circuit 120 of the analysis device 100 may calculate a basis vector of a new coordinate system indicated by dotted lines fixed to the interface between different materials. The basis of the original coordinate system is expressed as ex (bold)=(1,0,0), ey (bold)=(0,1,0), and ez (bold)=(0,0,1). The basis of the new coordinate system is expressed as ez′ (bold)=S (bold)/|S (bold)|, ex′ (bold)=A (bold)/|A (bold)|, ey′ (bold)=ez′ (bold)×ex′ (bold). The transformation law between the original coordinate system and the new coordinate system may be expressed as a matrix combining the dot products of their basis. The calculation circuit 120 may calculate the matrix shown in following Equation (6) based on the basis vector.

$$[ Equation 6 ]$$

$$R = [ \begin{matrix}{e}_{x}^{′} \cdot {e}_{x} & {e}_{x}^{′} \cdot {e}_{y} & {e}_{x}^{′} \cdot {e}_{z} \\ {e}_{y}^{′} \cdot {e}_{x} & {e}_{y}^{′} \cdot {e}_{y} & {e}_{y}^{′} \cdot {e}_{z} \\ {e}_{z}^{′} \cdot {e}_{x} & {e}_{z}^{′} \cdot {e}_{y} & {e}_{z}^{′} \cdot {e}_{z}\end{matrix} ] \qquad ( 6 )$$

A surface integral in the new coordinate system fixed at the interface of different materials may be calculated analytically. If the surface integral is Ftriangle (qx, qy), the scattering intensity distribution from one surface element when viewed from the original coordinates is expressed by following Equation (7).

$$[ Equation 7 ]$$

$$Δρ {\int }_{S} {e}^{- iq \cdot r} q \cdot dS = Δρ {e}^{- iq \cdot {r}_{0}} {q}_{z}^{′} {F}_{triangle} ( {q}_{x}^{′} , {q}_{y}^{′} ) \qquad ( 7 )$$

The calculation circuit 120 may calculate the scattering intensity distribution shown in equation (7) for all surface elements, perform transformation based on Equation (6), and may add the transformation results to each other according to following Equation (8), thereby calculating the scattering intensity distribution.

$$[ Equation 8 ]$$

$$\begin{matrix}I ( q ) = {\vert \frac{1}{V} {\int }_{V} ρ ( r ) exp ( - iq \cdot r ) {d}^{3} r \vert}^{2} \\ = \vert \frac{i}{{q}^{2} V} {\sum }_{k = 0}^{N - 1} {Δρ}_{k} {\int }_{{S}_{k}} {e}^{- iq \cdot r} q \cdot {dS}_{k} \vert\end{matrix} \qquad ( 8 )$$

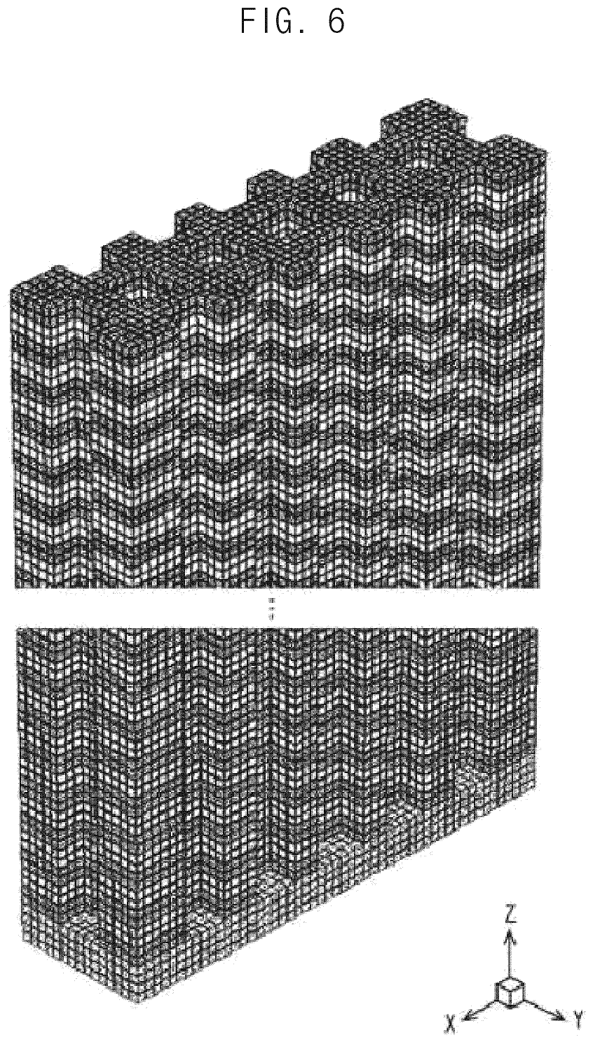

In a related art, the scattering intensity distribution when X-rays were irradiated to a target structure that is expressed as a rectangular parallelepiped mesh may be calculated by adding the analytical solutions of the scattering intensity distribution when X-rays were irradiated to one rectangular parallelepiped mesh over the entire target area. In this case, it may be necessary to convert the mesh representation of the target structure shown in FIG. 4 (e.g., based on unstructured mesh data) into a representation using the rectangular parallelepiped mesh shown in FIG. 6.

Meanwhile, according to an example embodiment 1, there is no need to convert the mesh data shown in FIG. 4 into the rectangular parallelepiped mesh data shown in FIG. 6, and the scattering intensity distribution may be calculated directly from the mesh data shown in FIG. 4. Additionally, unless there are extremely many different material interfaces, the amount of calculation in the analysis method according to example embodiments is small in comparison to the related art. In order to compare the related art with an example embodiment, the target structure shown in FIG. 4 was divided into 526 divisions in X direction, 152 divisions in Y direction, and 5200 divisions in Z direction. In addition, sampling points of X component qx[1/nm] and Y component qy[1/nm] of the scattering vector was set to 526 and 152, respectively, and the amount of time required to analyze the scattering intensity distribution was measured. When using the related art, the amount of time required to create the rectangular parallelepiped mesh was 16425 seconds, and the calculation time for the scattering distribution intensity was 11147 seconds. When using an example embodiment, generation of a rectangular parallelepiped mesh is unnecessary, and the calculation time for the scattering distribution intensity was 5 seconds. Accordingly, the analysis speed according to an example embodiment is 5514.4 (=(16425+11147)/5) times faster than the analysis speed according to the related art.

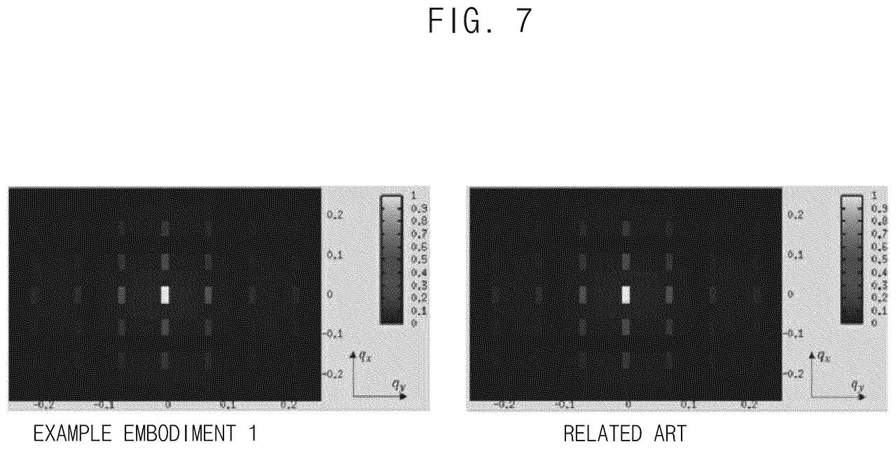

Additionally, as shown in FIG. 7, the results of calculating the scattering distribution using the related art and the results of calculating the scattering distribution using an example embodiment are consistent. For visibility, the square root of the scattering intensity distribution is drawn for a main part of the scattering vector, and normalized such that the intensity at qx=qy=0 is 1. For the entire calculated area, the maximum absolute value of the difference at each point between the calculation result according to an example embodiment and the calculation result according to the related art is 1.16*e-71, which is sufficiently small.

According to an example embodiment, the scattering intensity distribution when X-rays are irradiated to the target structure are calculated by using a surface integral rather than a volume integral, and thus the amount of time required for calculation may be reduced. Additionally, there is no need to convert the mesh data of the target structure into rectangular parallelepiped mesh data.

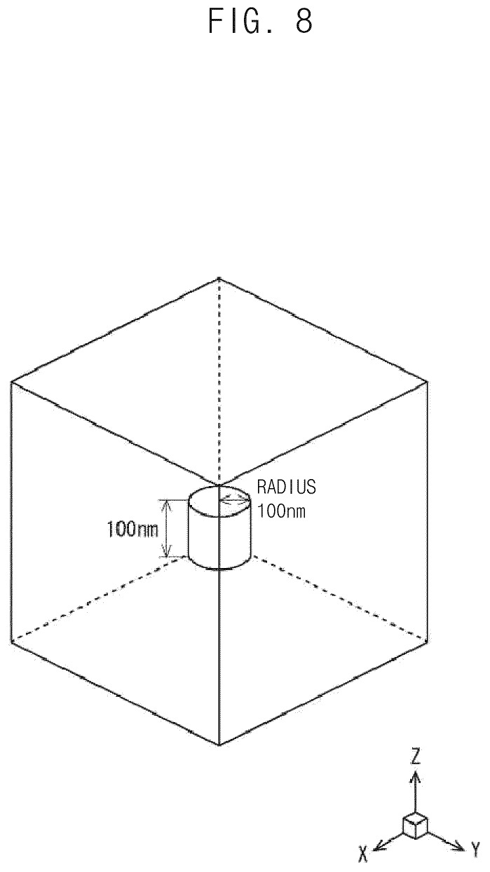

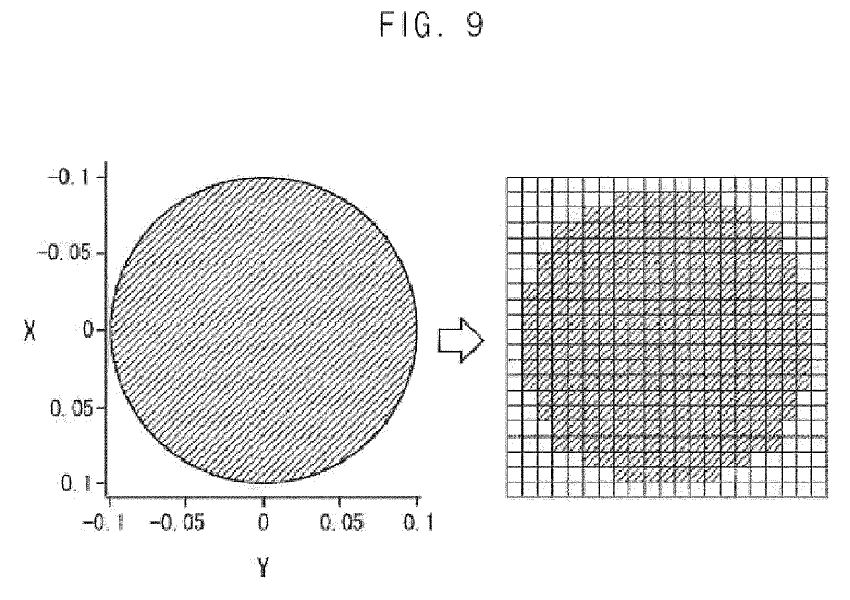

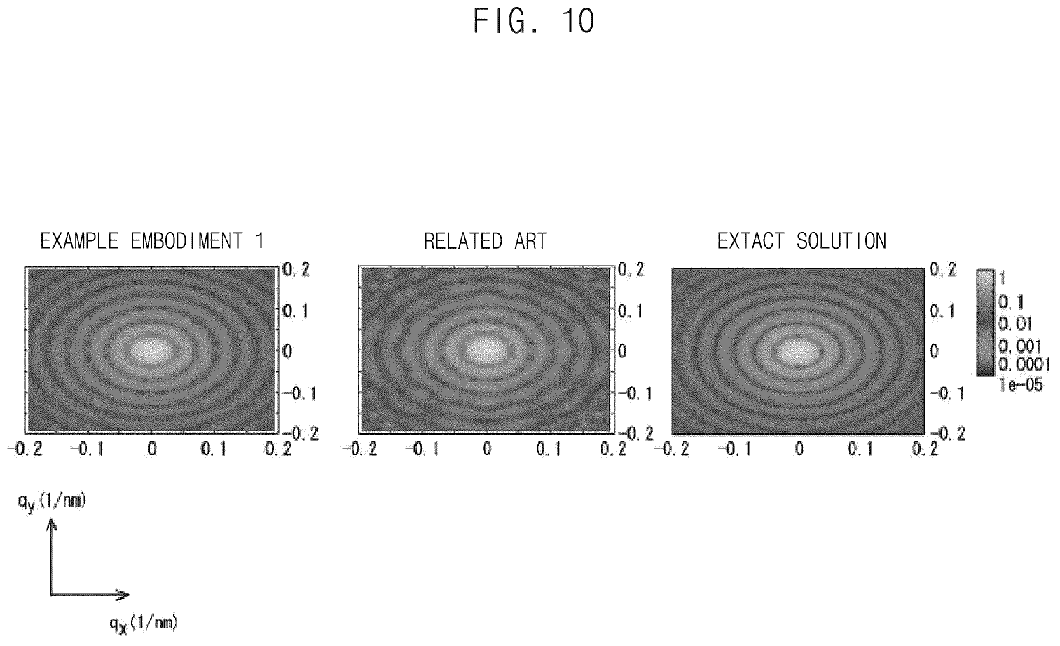

Other effects or advantages include the following. Both the method of adding the analytical solution of a rectangular parallelepiped mesh over the entire area and the method of adding the result of applying Fast Fourier transform in XY direction in the Z direction may express the target structure of simulation as a small cuboid, so surfaces that are inclined relative to the reference coordinates or curved surfaces may become jagged, which may reduce simulation accuracy. To prevent this, it may be advantageous to use a sufficiently fine rectangular mesh, but in that case, the number of meshes increases and the calculation time may become unreasonable. Since an example embodiment does not perform conversion to a rectangular parallelepiped mesh, the scattering intensity distribution may be obtained from structural data in a form closer to the original without causing a decrease in precision or an increase in calculation time due to discretization of the target structure as described above. For example, when calculating the scattering intensity distribution by a cylindrical target structure with a radius of 100 nm and a height of 100 nm shown in FIG. 8 using the related art, the circle is expressed using a rectangular parallelepiped (square) mesh as shown in FIG. 9, and is not a strict circle in XY direction or plane, so the scattering intensity distribution is distorted. Since there is no need to express the cylinder as a rectangular cell (e.g., as a square mesh) in an example embodiment, an example embodiment can obtain a scattering intensity distribution that is closer to an exact solution than the related art, as shown in FIG. 10.

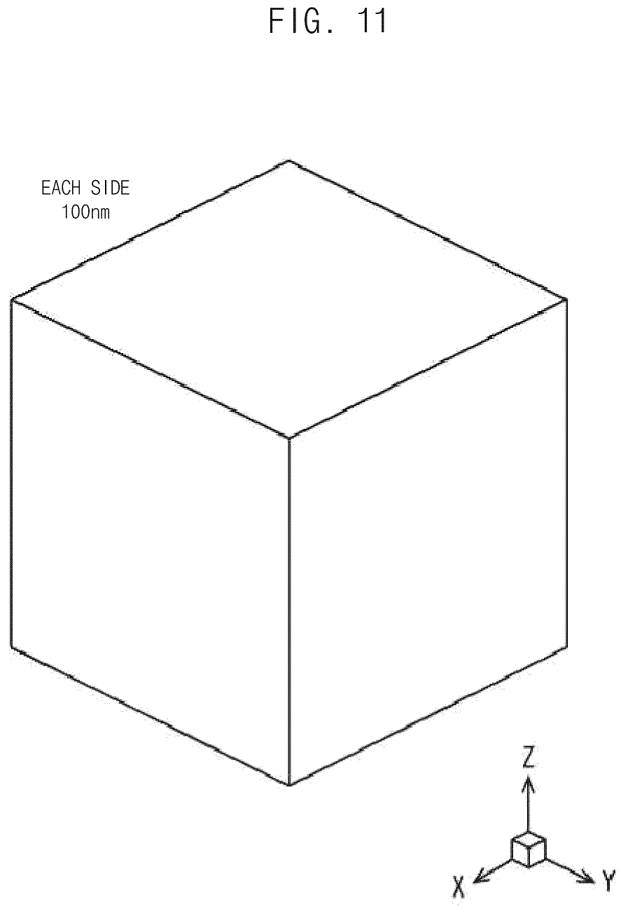

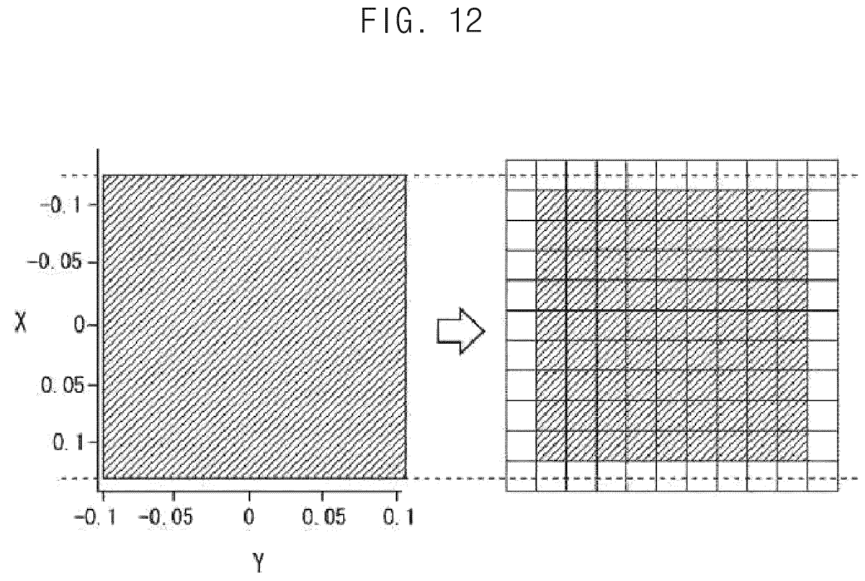

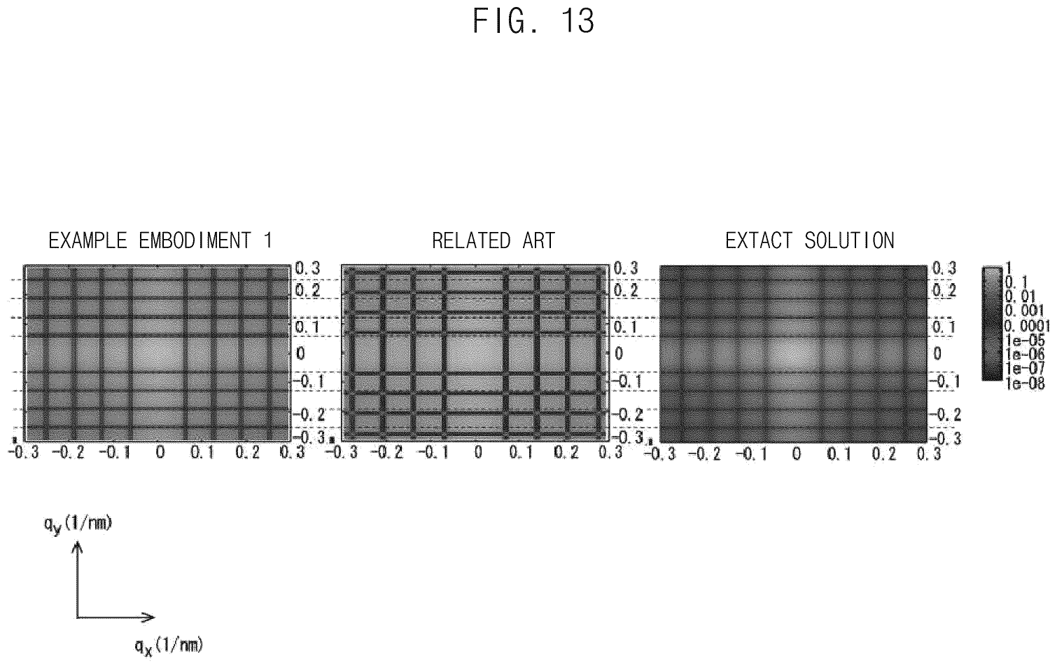

Additionally, in case of using the Fast Fourier transform, because it may be necessary to use a uniform mesh for the XY direction, even if there is no curved or tilted plane, when converting to a uniform rectangular mesh, the interfaces between different materials may be shifted from their original positions. In an example embodiment, since the conversion itself to a rectangular parallelepiped mesh is not performed, such a problem does not occur. For example, when calculating the scattering intensity distribution from a rectangular cuboid with each side of 100 nm shown in FIG. 11, when the rectangular cuboid is expressed as a rectangular parallelepiped mesh, as shown in FIG. 12, the positions of the interfaces between different materials are misaligned. Accordingly, when using the related art, as shown in FIG. 13, the position of the originally appearing zero point deviates from the exact solution. On the other hand, an example embodiment can calculate a scattering intensity distribution that more closely matches the exact solution.

The figures herein illustrate the architecture, functionality, and operations of embodiments of hardware and/or software according to various embodiments of the present invention. It will be understood that each block of a block diagram illustration, and combinations of blocks in the block diagram illustrations, may be implemented by computer program instructions and/or hardware operations. In this regard, each block represents a module, segment, or portion of code, which comprises one or more executable instructions for implementing the specified logical function(s). It should be noted that, in other implementations, the function(s) noted in or associated with the blocks may occur out of the order noted in the figures.

The computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the block diagram block or blocks. The computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The foregoing is illustrative of example embodiments and is not to be construed as limiting thereof. Although a few example embodiments have been described, those skilled in the art will readily appreciate that many modifications are possible in example embodiments without materially departing from the teachings and advantages of the present invention. Accordingly, all such modifications are intended to be included within the scope of example embodiments as defined in the claims.

What is claimed is:

1. An X-ray analysis device, comprising:
an extraction circuit that is configured to extract information about an electron density difference at an interface between different materials included in a target structure and information about a surface element included at the interface from data representing the target structure; and
a calculation circuit that is configured to calculate a surface integral at the interface based on the information about the electron density difference and the information about the surface element, and to calculate a scattering intensity distribution of X-rays irradiated to the target structure based on the surface integral.

2. The X-ray analysis device of claim 1, wherein the interface between the different materials included in the target structure comprises a first different material interface and a second different material interface having a same shape,
wherein the extraction circuit is configured to store the information about the surface element of the first different material interface in a storage circuit, and
wherein the calculation circuit is configured to use information based on the information about the surface element of the first different material interface read from the storage circuit as information about a surface element of the second different material interface.

3. The X-ray analysis device of claim 1, wherein the calculation circuit is configured to classify the surface element into one of a plurality of groups according to a direction of the surface element, and to calculate the surface integral based on a classification result.

4. The X-ray analysis device of claim 1, wherein the calculation circuit is configured to calculate a respective surface integral for each of a plurality of surface elements at respective interfaces between different materials, and calculate the scattering intensity distribution based on a sum of the respective surface integrals.

5. The X-ray analysis device of claim 4, wherein the calculation circuit is configured to allocate the respective surface integral of each of the plurality of the surface elements to one of a plurality of processor cores, and to execute parallel processing in the plurality of processor cores.

6. The X-ray analysis device of claim 1, wherein the data representing the target structure comprises unstructured mesh data, and wherein the calculation circuit is configured to calculate the scattering intensity distribution without generation of rectangular parallelepiped mesh data from the unstructured mesh data.

7. The X-ray analysis device of claim 1, wherein the information regarding the electron density difference represents a difference between a first electron density corresponding to a first side of the interface and a second electron density corresponding to a second side of the interface opposite to the first side.

8. An X-ray analysis device, comprising:
an extraction circuit that is configured to extract, from data representing a target structure, information about an electron density difference at an interface between different materials included in the target structure and information about a surface element included at the interface; and
a calculation circuit that is configured to calculate a surface integral at the interface based on the information about the electron density difference and the information about the surface element and to calculate a scattering intensity distribution of X-rays irradiated to the target structure based on the surface integral,
wherein the data representing the target structure comprises unstructured mesh data, and wherein the calculation circuit that is configured to calculate the scattering intensity distribution without generation of rectangular parallelepiped mesh data from the unstructured mesh data.

9. The X-ray analysis device of claim 8, wherein the interface between the different materials included in the target structure comprises a first different material interface and a second different material interface having a same shape,
wherein the extraction circuit is configured to store the information about the surface element of the first different material interface in a storage circuit, and
wherein the calculation circuit is configured to use information based on the information about the surface element of the first different material interface read from the storage circuit as information about a surface element of the second different material interface.

10. The X-ray analysis device of claim 8, wherein the calculation circuit is configured to classify the surface element into one of a plurality of groups according to a direction of the surface element, and to calculate the surface integral based on a classification result.

11. The X-ray analysis device of claim 8, wherein the calculation circuit is configured to calculate a respective surface integral for each of a plurality of surface elements at respective interfaces between different materials, and calculate the scattering intensity distribution based on a sum of the respective surface integrals.

12. The X-ray analysis device of claim 11, wherein the calculation circuit is configured to allocate the respective surface integral of each of the plurality of the surface elements to one of a plurality of processor cores, and to execute parallel processing in the plurality of processor cores.

13. An X-ray analysis device, comprising:
at least one processor; and
memory comprising a non-transitory storage medium having instructions stored therein that, when executed by the at least one processor, cause the X-ray analysis device to:
extract, from data representing a target structure, information about an electron density difference at an interface between different materials included in the target structure and information about a surface element included at the interface;
calculate a surface integral at the interface based on the information about the electron density difference and the information about the surface element; and
calculate a scattering intensity distribution of X-rays irradiated to the target structure based on the surface integral.

14. The X-ray analysis device of claim 13, wherein the interface between the different materials included in the target structure comprises a first different material interface and a second different material interface having a same shape, and wherein the instructions, when executed by the at least one processor, further cause the X-ray analysis device to:
store the information about the surface element of the first different material interface in a storage circuit; and
use information based on the information about the surface element of the first different material interface read from the storage circuit as information about a surface element of the second different material interface.

15. The X-ray analysis device of claim 13, wherein the instructions, when executed by the at least one processor, further cause the X-ray analysis device to:
classify the surface element into one of a plurality of groups according to a direction of the surface element; and
calculate the surface integral based on a result of the classifying.

16. The X-ray analysis device of claim 13, wherein the instructions, when executed by the at least one processor, further cause the X-ray analysis device to:
calculate a respective surface integral for each of a plurality of surface elements at respective interfaces between different materials; and
calculate the scattering intensity distribution based on a sum of the respective surface integrals.

17. The X-ray analysis device of claim 16, wherein the instructions, when executed by the at least one processor, further cause the X-ray analysis device to:
allocate the respective surface integral of each of the plurality of the surface elements to one of a plurality of processor cores; and
operate the plurality of processor cores to execute parallel processing to calculate the respective surface integrals.

18. The X-ray analysis device of claim 13, wherein the data representing the target structure comprises unstructured mesh data, and wherein the instructions, when executed by the at least one processor, further cause the X-ray analysis device to:
calculate the scattering intensity distribution without generation of rectangular parallelepiped mesh data from the unstructured mesh data.

19. The X-ray analysis device of claim 13, wherein the information regarding the electron density difference represents a difference between a first electron density corresponding to a first side of the interface and a second electron density corresponding to a second side of the interface opposite to the first side.

20. The X-ray analysis device of claim 13, wherein a plane wave X-ray is irradiated to the target structure having periodicity.
